(19) United States
(12) Patent Application Publication
(10) Pub. No.: US 2025/0144586 A1
(43) Pub. Date: May 8, 2025

(54) INTERNAL CIRCULATION CATALYTIC REACTOR AND METHOD

(71) Applicant: KING ABDULLAH UNIVERSITY OF SCIENCE AND TECHNOLOGY, Thuwal (SA)

(72) Inventors: Pedro CASTANO, Thuwal (SA); Mengmeng CUI, Thuwal (SA); Shekhar Rajabhau KULKARNI, Thuwal (SA)

(21) Appl. No.: 18/837,400

(22) PCT Filed: Jan. 10, 2023
(86) PCT No.: PCT/IB2023/050212

§ 371 Date: Aug. 9, 2024

Related U.S. Application Data
(60) Provisional application No. 63/309,050, filed on Feb. 11, 2022.

(51) Int. Cl. B01J 8/02; B01J 4/00

(52) U.S. Cl. CPC B01J 8/025; B01J 4/007; B01J 8/0278; B01J 8/0292; B01J 2208/00876; B01J 2208/00938; B01J 2219/00011

(57) ABSTRACT

An internal circulation catalytic reactor includes a body extending along a longitudinal axis Z and defining an internal chamber, a catalyst bed located within the internal chamber, the catalyst bed being configured to hold a catalyst, an inlet fluidly connected to the catalyst bed and configured to receive a feed, an outlet fluidly connected to the catalyst bed and configured to discharge a product generated by an interaction of the feed and the catalyst, and an impeller fluidly connected to the catalyst bed and configured to circulate the feed through the catalyst bed. The impeller is configured to discharge a recirculate feed at a non-zero angle relative to a horizontal radial axis R.

### CROSS-REFERENCE TO RELATED APPLICATIONS

This application claims priority to U.S. Provisional Patent Application No. 63/309,050, filed on Feb. 11, 2022, entitled “INTERNAL CIRCULATION CATALYTIC REACTOR AND METHOD,” the disclosure of which is incorporated herein by reference in its entirety.

### BACKGROUND

### Technical Field

Embodiments of the subject matter disclosed herein generally relate to an internal circulation (Berty) catalytic reactor for continuous and/or discontinuous processes, and more particularly, to a catalytic reactor having a curved impeller, smaller height, and rounder shape for improved interactions between the stationary and rotating zones in the reactor to better utilize the momentum generated by the impeller for relatively short contact time or fluidizing the catalysts under continuous/discontinuous operating conditions.

### Discussion of the Background

Many industries, for example, chemical, petrochemical, and pharmaceutical, are using one or more catalysts for achieving the desired output while performing chemical reactions. For example, in the petrochemical environment, the petroleum stock is passed through a bed of catalyst particles (catalytic cracking) for obtaining the desired light oils, gasolines, and similar products. However, there is a lack of models and data about how a particular catalyst interacts with a given feed for a specific chemical reactor. In other words, the characteristics of the reactor, the location of the catalyst inside the reactor, and other factors strongly influence the chemical reactions taking place and thus, there is a need for testing the environment in which the chemical reactions take place before deciding on a specific reactor and/or a specific catalyst. The same problems plaque the regeneration of cracking catalysts, which are important, as the combustion of coke has a significant effect on the overall thermal balance of the reactor and the plant in which the reactor is integrated.

One way for achieving this goal is to use a laboratory scale testing unit. An example of such a unit, called a Berty catalytic reactor, is disclosed in [1] and presented in FIG. 1, which corresponds to FIG. 1 of [1]. FIG. 1 shows the reactor 100 designed to reproduce the operating reacting conditions of industrial applications as fluid catalytic cracking, oxidative coupling of methane, methane decomposition, dry reforming of methane, methanol to hydrocarbons, crude to chemicals catalytic processes.

The reactor 100 can be split into a bottom part (vessel) 102 and a top part (lid) 104. The vessel 102 contains threads, into which studs 106 are screwed. The lid 104 is placed onto these studs 106, much like a flange coupling, and tightened with nuts 108 screwed onto the studs 106. The vessel 102 contains the main reaction volume 112, where a cylindrical basket 110 acts as a separating wall between the center, in which the catalyst is placed, and the outer fluid volume 114, through which the recycled flow 116 passes. An impeller 118 is located on top of the basket 110. A main inlet 120 is located at the bottom of the vessel 112, for supplying the feed. An outlet 122 is located at the sidewall, slightly lower than the impeller 118. The impeller 118 is rotated to radially accelerate the fluid so as to create the recycled flow 116, from the inlet 120 to the outlet 122, which is therefore circulated from the top, along the annular side of the reactor, to the bottom. Therefore, the recycled flow 116 is sucked into the catalyst bed (located inside the basket 110), in which the catalytic particles are kept between two screens located at the top and bottom of the bed to perform reactions in this specific zone, and finally reaches again the impeller 118. Note that the impeller 118 is shaped to have a flat top part 123 and an upwardly angled bottom part, as illustrated by reference number 124.

This specific configuration in [1] has been found to not be as efficient as desired. The inventors have evaluated the hydrodynamic characteristics (fluid velocity and pressure inside the reactor) of the Berty reactor 100 by experiment-validated simulations in the continuous/discontinuous packed bed modes. The low velocity/pressure of the impeller center indicates a dead volume at region 202, as illustrated in FIGS. 2A, 2B, 2C and 2D. It was observed that a momentum loss is present with a relatively low velocity through the circulation zone at region 204 (shown in FIGS. 2B and 2D). With a high velocity of the impeller outlet at region 206, the fact is that the momentum generated by the impeller 118 was not effectively transferred to the stationary recirculation zone at region 204 (see FIGS. 2B and 2D) during the packed-bed mode of the Berty reactor 100. A further decrease of the velocity in the catalyst bed at region 208 results in long contact time between the feed and the catalysts, which can be hardly adjusted by changing the rotation rates for reproducing the operating conditions of short contact time or to fluidize the catalysts.

Thus, there is a need for a new reactor configuration that is capable of providing better speed and pressure distributions inside the reactor, to better utilize the momentum generated by the impeller and reproduce the desired packed/fluidized environment of operating conditions from the lab scale for the actual processes in an actual plant.

### BRIEF SUMMARY OF THE INVENTION

According to an embodiment, there is an internal circulation catalytic reactor that includes a body extending along a longitudinal axis Z and defining an internal chamber, a catalyst bed located within the internal chamber, the catalyst bed being configured to hold a catalyst, an inlet fluidly connected to the catalyst bed and configured to receive a feed, an outlet fluidly connected to the catalyst bed and configured to discharge a product generated by an interaction of the feed (516) and the catalyst, and an impeller fluidly connected to the catalyst bed (506) and configured to circulate the feed through the catalyst bed. The impeller is configured to discharge a recirculate feed at a non-zero angle relative to a horizontal radial axis R.

According to another embodiment, there is an impeller for an internal circulation catalytic reactor, and the impeller includes an impeller body, a top curved plate attached to the impeller body, the top curved plate having a proximal end that extends radially from the impeller body, and having a distal end that extends along a direction that makes a non-zero angle with the radial axis R, and a bottom inclined plate that defines with the top curve plate a rotational zone in which a feed is rotated.

According to still another embodiment, there is a method for selecting a catalyst with an internal circulation catalytic reactor. The method includes loading a catalyst into a catalyst bed, which is located within an internal chamber of the reactor, injecting a feed at an inlet of the reactor, the inlet being fluidly connected to the catalyst bed, circulating the feed through the catalyst bed with an impeller which is fluidly connected to the catalyst bed, discharging at an outlet a product that results from an interaction of the catalyst with the feed, and recirculating a remainder of the feed through the catalyst bed with the impeller. The impeller is configured to discharge the recirculated feed at a non-zero angle relative to a horizontal radial axis R.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of an internal circulation catalytic reactor;

FIGS. 2A to 2D illustrate the pressure and velocity distribution of a feed inside the internal circulation catalytic reactor;

FIG. 3 shows a novel impeller for an internal circulation catalytic reactor;

FIG. 4 shows a traditional impeller for the internal circulation catalytic reactor;

FIG. 5 shows a novel internal circulation catalytic reactor having the novel impeller shown in FIG. 3;

FIG. 6 shows the internal circulation catalytic reactor with the novel impeller of FIG. 3;

FIGS. 7A and 7B show the velocity and interaction time between the feed and the catalyst versus the speed of the impeller for a traditional reactor;

FIGS. 8A and 8B show the velocity and interaction time between the feed and the catalyst versus the speed of the impeller for the novel impeller of FIG. 3; and

FIG. 9 is a flow chart of a method for selecting a catalyst in the internal circulation catalytic reactor in continuous mode of FIG. 5 or 6; and

FIG. 10 is a flow chart of a method for selecting a catalyst in the internal circulation catalytic reactor in discontinuous mode of FIG. 5 or 6.

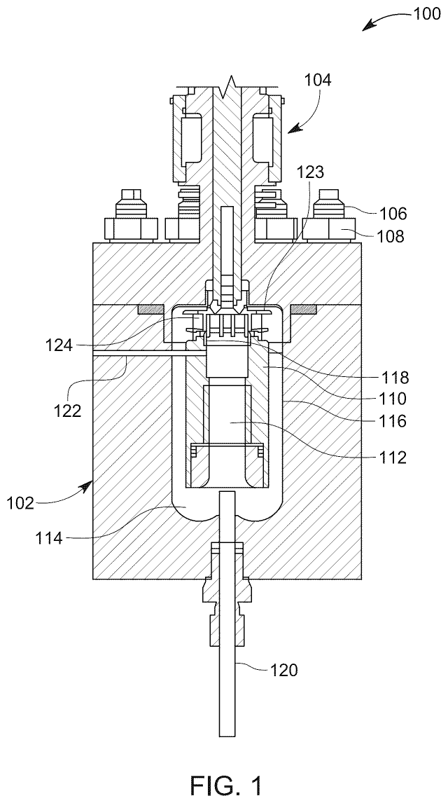

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a lab scale Berty reactor. However, the embodiments to be discussed next are not limited to a lab scale reactor or a Berty reactor, but may be applied to actual size reactors or reactors other than a Berty reactor.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a novel Berty reactor has an impeller configured to have an aerodynamic shape so that an interaction between a stationary zone and a rotating zone of the reactor takes place in both the horizontal and vertical directions. In one variation, a height of the reactor is shortened to reduce a momentum loss of the recirculated flow. In yet another variation, the shape of the reactor body is made curved, to improve the velocity and pressure distribution of the recirculated flow. Note that the above noted features, which are discussed in more detail below, may be combined in any way, i.e., any two of them or all of them in a given reactor. Of course, the novel reactor may include only one of these features.

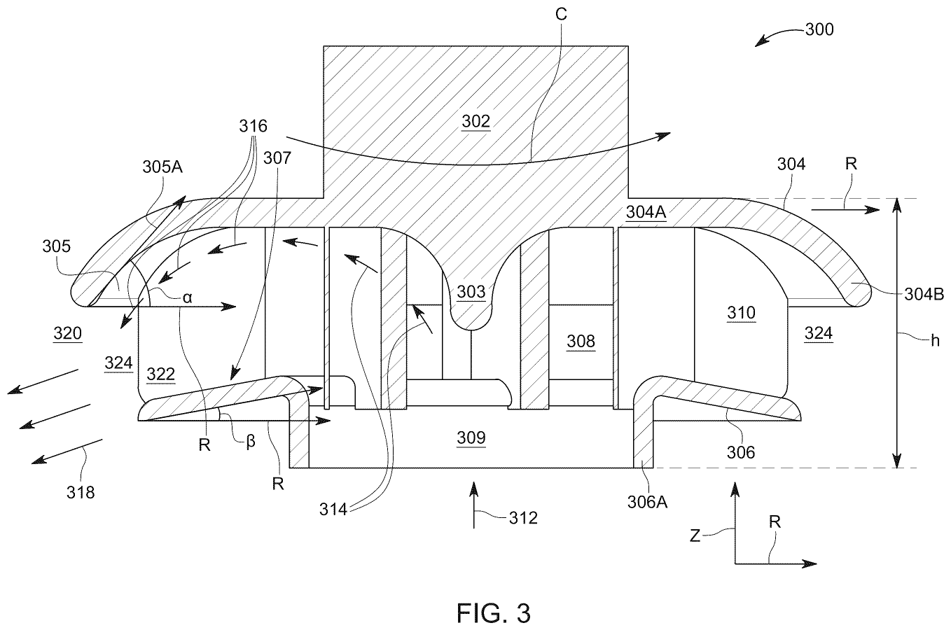

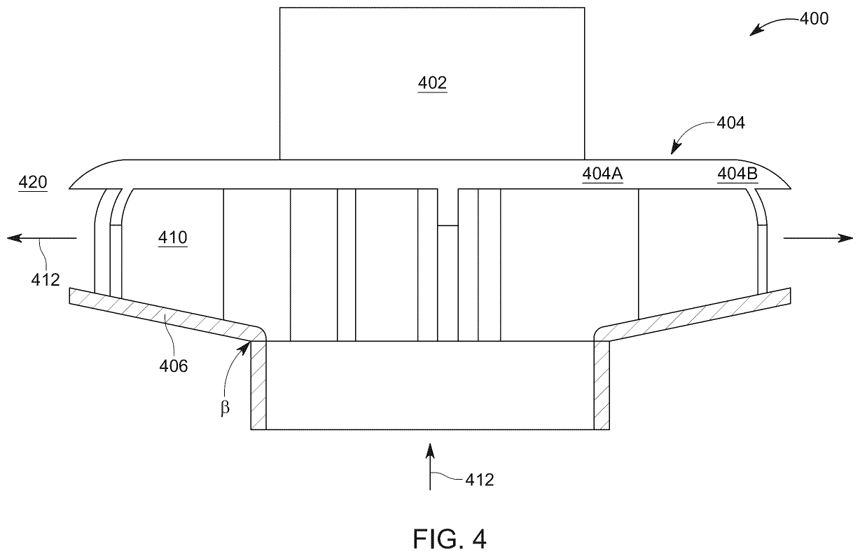

A novel aerodynamic impeller 300 is shown in FIG. 3 and is now discussed in more detail. A traditional impeller 400 is shown in FIG. 4, for comparison reasons. The impeller 300 has a body 302 from which a top curved plate 304 extends radially (along axis R) and circularly (along circular axis C). A bottom inclined plate 306 also extends, radially and circularly, from and around a body 306A. The body 306A defines a feed inlet 309, through which the feed 312 is received. The space 308 defined by the top curved plate 304 and the bottom inclined plate 306 is divided by plural vanes 310. The vanes 310 extend along a longitudinal axis Z of the body 302 and are perpendicular or inclined relative to the top curved plate 304 and the bottom inclined plate 306. The vanes 310 physically connect the top curved plate and the bottom inclined plate to each other. The longitudinal axis Z is perpendicular to the radial axis R. The feed 312 entering the inlet 309 is rotated with the vanes 310, thus forming the rotational volume 322, and then expelled into the stationary zone 320, just outside the impeller 300, through outlets 324 divided by the vanes 310.

The body 302 has a water drop-shaped region 303, which extends below the top curved plate 304, but remains above the bottom inclined plate 306, as shown in FIG. 3. The region 303 is located, in one embodiment, central to the top curved plate 304. This water drop-shaped region 303 forces the incoming feed 312 to have a curved, smooth flow, as indicated by arrows 314 and also reduces a dead zone inside the volume 308. The proximal part 304A of the top curved plate 304 extends along a straight line (radial axis R) from the body 302, and only the distal part 304B of the top curved plate 304 is curved, downwardly, as also shown in FIG. 3. Both the water drop-shaped region 303 of the body 302 and the top curved plate 304 are different from the body 402 of the traditional impeller 400, and the straight top plane 404, respectively. Note that the straight top plate 404 has the interior proximal surface 404A and the interior distal surface 404B straight, i.e., extending in a same 2D plane, while the internal surface of the proximal part 304A is straight and each of the interior and exterior surfaces of the distal part 304B are curved. Also note that the interior surface 305 of the distal part 304B is curved with an angle α relative to the radial axis R, as shown in FIG. 3. In one application, the interior surface 305 extends along an axis 305A, and the curvature angle between this axis 305A and the radial axis R is between 15° and 80°, depending on the application. This angle further makes the feed 312 to have a curved flow, as indicated by arrows 316 within the impeller. The flow of the feed 312 when exiting the impeller 300 is along the axis 305A, as indicated by arrow 318, i.e., makes a non-zero angle with the radial axis R. This means that exiting flow 318 makes a non-zero angle with both the radial axis R and the vertical axis Z, so that an interaction between the stationary area or volume 320 and the rotational area or volume 322 is improved relative to the traditional reactor 100.

The internal surface 307 of the bottom inclined plate 306 makes an angle α with the radial axis R, as also shown in FIG. 3. In one embodiment, the internal surface 307 of the bottom inclined plate 306 is flat, i.e., it extends in a 2D plane. The angle α may have a value between 0° and 30°. Note that the corresponding bottom plate 406 of the traditional impeller 400 in FIG. 4 is inclined to the R direction with an obtuse angle.

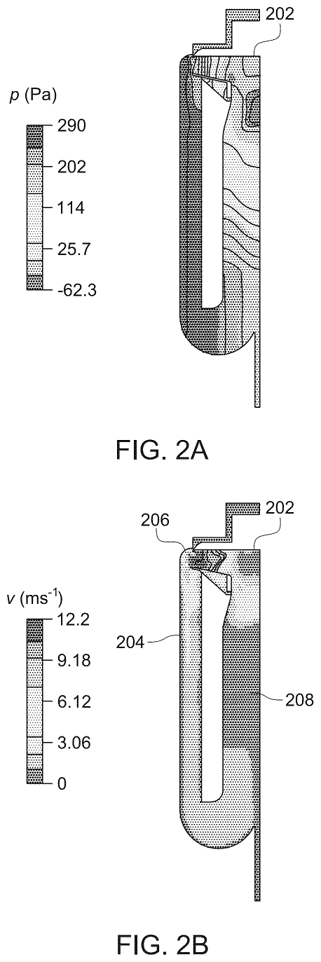

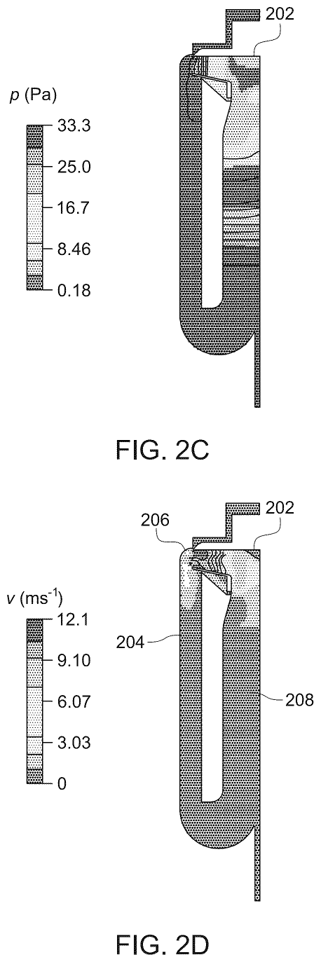

The curved internal surface 305 of the top curved plate 304 and the inclined internal surface 307 of the inclined bottom plate 306 determine an enlarged opening 324 of the impeller (which helps with the problems discussed above with regard to regions 206 in FIGS. 2B and 2D), but also promote the momentum transfer from the rotating impeller 300 to the adjacent stationary zone 320 of the reactor, by avoiding the direct strike to the perpendicular orientation. In other words, the feed 312 that is accelerated by the impeller 300, when exiting the impeller, as illustrated by arrows 318, makes a non-zero angle with both the longitudinal axis Z and the radial axis R, so that the feed 312 does not strike the stationary zone 320 perpendicularly, as is the case for the traditional impeller 400 or other reactors [2], where the exiting feed 412 is along the radial direction R and perpendicular on the axis Z, as shown in FIG. 4. Note that because the feed 312, when exiting the impeller 300, actually makes a non-zero angle with the radial axis R, the feed 312 has a velocity component along the radial axis R and a velocity component along the longitudinal axis Z. In addition, the inclined internal surface 307 with the water drop-shape part 303 of the body 302 reduce the dead volume in the center of the impeller, which is a problem for the traditional impellers (see above discussion with regard to regions 202 in FIGS. 2A, 2B, 2C and 2D). The height h of the impeller 300 can be selected to be between 10 and 25 mm. The height h is selected according to the catalyst bed dimension to reproduce various testing conditions.

The novel impeller 300 is shown in FIG. 3 having both the top curved plate 304 and the bottom inclined plate 306 with the features discussed above. However, in one embodiment, it is possible that only one of the two plates 304 and 306 have the characteristics shown in FIG. 3 and the other one has the characteristics shown in FIG. 4.

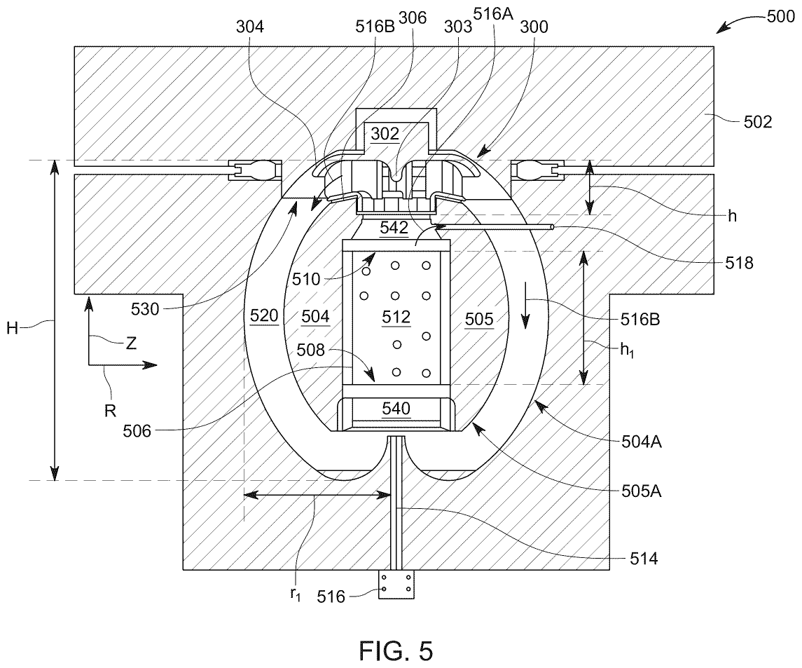

The novel impeller 300 is shown in FIG. 5 being placed inside the body 502 of the reactor 500. FIG. 5 further shows the body 502 having an interior chamber 504 in which a catalyst bed 506 is placed. In one embodiment, the catalyst bed 506 is placed within a catalyst basket 505 and the catalyst basket 505 is placed within the interior chamber 504. The catalyst basket 505 separates the catalyst bed 506 from an annulus 520, to create an internal circulation. The catalyst bed 506 includes a lower screen 508 and an upper screen 510 that hold the catalyst particles 512 confined within the bed. A height of the catalyst bed 506 is h1. The interior chamber 504 is fluidly connected to an inlet 514, which supplies the feed 516, for example, extracted oil. The feed 516 may be any chemical used in the chemical, petrochemical or pharmaceutical industry. The interior chamber 504 is also connected to an outlet 518, through which the product, e.g., cracked gas or liquid, is removed from the reactor. Note that the inlet 514 is located at the bottom of the reactor 500 in this embodiment, however, other arrangements as side injection or top injection are also possible. Note that the outlet 518 is located below the impeller 300 in this embodiment, however, other arrangements are also possible.

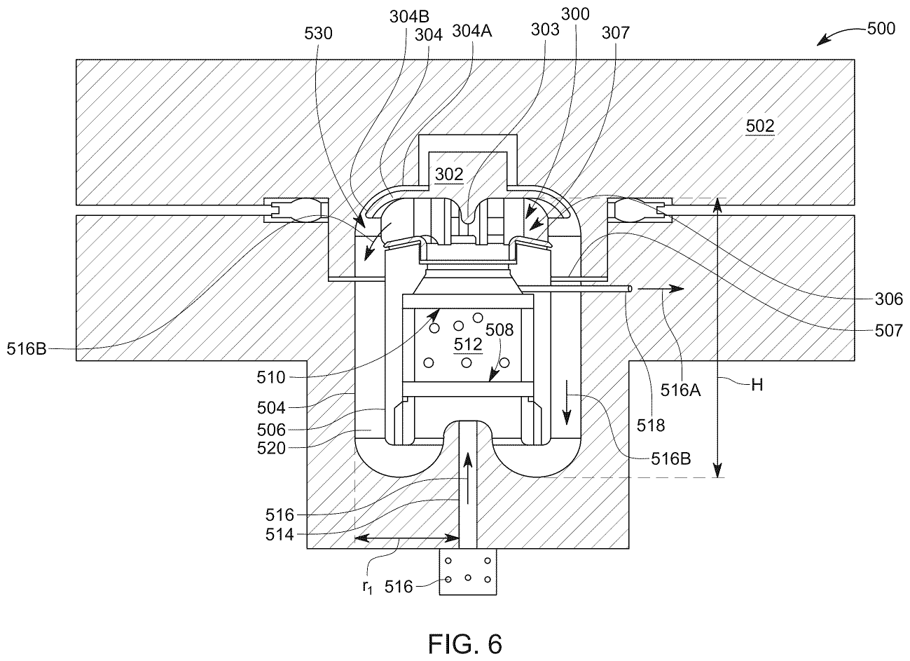

The output feed 516A from the impeller 300 enters a stationary zone 530, located in an annulus 520, and then circulates along a curved path in the annulus 520. The curved path is defined by the recirculation height (H in FIG. 5) and the biggest radius (R1 in FIG. 5) of the exterior surface 504A, to form a smooth path for the recycle flow 530 towards the center of the interior chamber 504, for which the parameters of H1 and R1 may change accordingly based on dimensions of other parts. In this embodiment, the annulus 520 is a curved annulus formed between the inner surface 504A of the interior chamber 504 and the outer wall 505A of catalyst basket 505. In this embodiment, the entire length of the annulus 520 is curved. However, in another embodiment as illustrated in FIG. 6, the annulus 520 may be only partially curved, next to the impeller 300 and next to the inlet 514. In this way, the feed 516 is forced to circulate through the reactor 500 (for example, with one small part 516A being optionally extracted at the outlet 518, while the other part 516B being recirculated), through the catalyst bed 506 and through the annulus 520.

In another embodiment, which may be combined with the embodiments discussed herein or may be a standalone embodiment, a reduction of the recirculation height (see H in FIGS. 5 and 6) prevents the reactor from the non-effective circulation and momentum loss. However, this height is limited to the manufacture capability with the goal of reproducing the catalytic reacting conditions. As it is required to collect enough samples after each reaction, the height h1 of the catalytic bed (see FIG. 5) should be calculated according to the radius r1 of the bed to fill a certain amount of catalysts. In consideration of the screens 508 and 510 to be placed at the top and bottom of the catalyst bed 506, and the impeller 300, the recirculation height H can be from 35 to 80 mm. The ratio of the impeller height h to the bed height h1 can be from ⅓ to 2.

In yet another embodiment, the round shape of the annulus 520 can be selected to have a more or less curved shape, to generate a gentle flow from the rotating impeller 300 to the stationary circulation zone 530, to reduce the direct strike to the reactor sidewall. When a relatively short contact time between the feed 516 and the catalyst particles 512 is required, the annulus 520 can be selected to look like a fat-short apple with the circulation height H of about 35 mm and a ratio of h/h1 of about 1 to 2 by adjusting the impeller height h and the bed height h1. The radius r1 of the catalyst bed 506 is restricted to a lower bound for filling the desired amount of catalyst by using the formula

$${r}_{1 min} = \sqrt{\frac{m}{π {h}_{1} ρ}} ,$$

where m is the catalyst weight, r1 is the bed radius, h1 is the bed height, and p is the particle density. In addition, various combinations for the impeller, reactor body and catalytic bed in the proposed ranges can be utilized for different reacting conditions.

In one embodiment, the diameter of the catalyst bed 506 is configured to decrease, when advancing along the longitudinal axis Z, from the inlet 514 toward the outlet 518. For example, FIG. 5 shows a base region 540 on which the catalyst bed 506 sits and a connection region 542, that fluidly connects the catalytic bed 506 to the impeller 300. The diameter of the catalytic bed 506 is larger than the diameter of the connection region 542, and the diameter of the base region 540 is larger than the diameter of the catalytic bed 506. In one embodiment, the diameters of the base region 540 and the connection region 542 continually change from a corresponding first value to a corresponding second value, which is smaller than the first value.

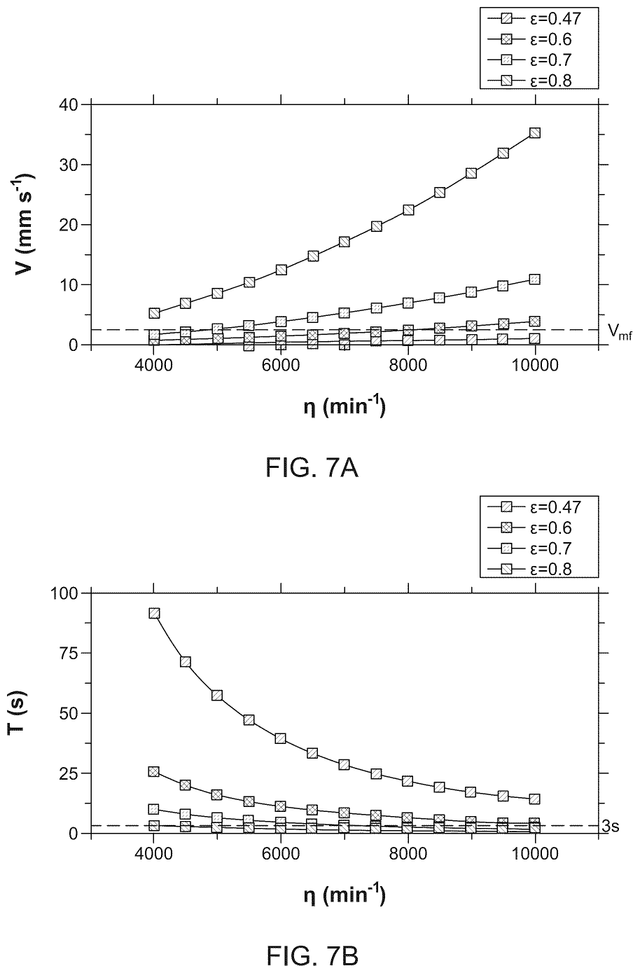

The performance of the traditional reactor 100 having the impeller 400 is now compared with the performance of the novel reactor 500 having the new impeller 300. With the momentum generated from the impeller, the particles in the catalytic bed can be fluidized under certain circumstances, so the inventors evaluated the reactor's performance in the fluidized-bed mode. Since the fluidized bed reactors are commonly selected for highly exothermic, endothermic, or explosive catalytic reactions where the catalysts deactivate in minutes or seconds, reproducing a relatively short contact time of about 3 s between the catalysts and the gas in the fluidized-bed mode would be attractive for catalyst screening under certain applications as crude to chemicals. However, it is beyond the capability of the traditional reactor 100 at the operating rotation rate of 3,000-8,500 min⁻¹ (recommended by the supplier for maintaining a safe and reliable system) due to the relatively low bed velocity. FIG. 7A shows the bed velocity for the traditional Berty reactor 100, where the velocity vis plotted on the y axis, and the operating rotation rate η of the impeller is plotted on the x axis. The plural curves shown in FIG. 7A correspond to different values of ε, where ε is the bed porosity, and a value of 0.47 means a packed bed. FIG. 7B shows the single round contact time, also plotted against the operating rotation rate η of the impeller.

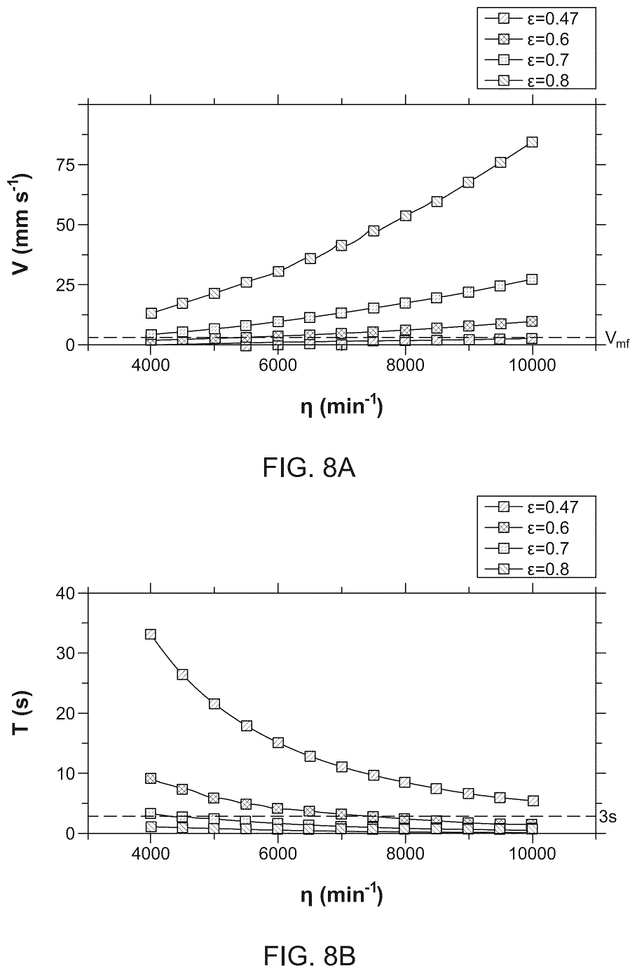

When the same quantities are plotted for the reactor 500 with the novel impeller 300 and the curved annulus 520, as shown in FIGS. 8A and 8B, the performance of the reactor is improved, for example, almost twice for the bed velocity and a contact time of 3 s can be now achieved at the operating rotation rate of 3,000 to 8,500 min⁻¹ by adjusting the catalyst loading for a bed porosity of 0.7.

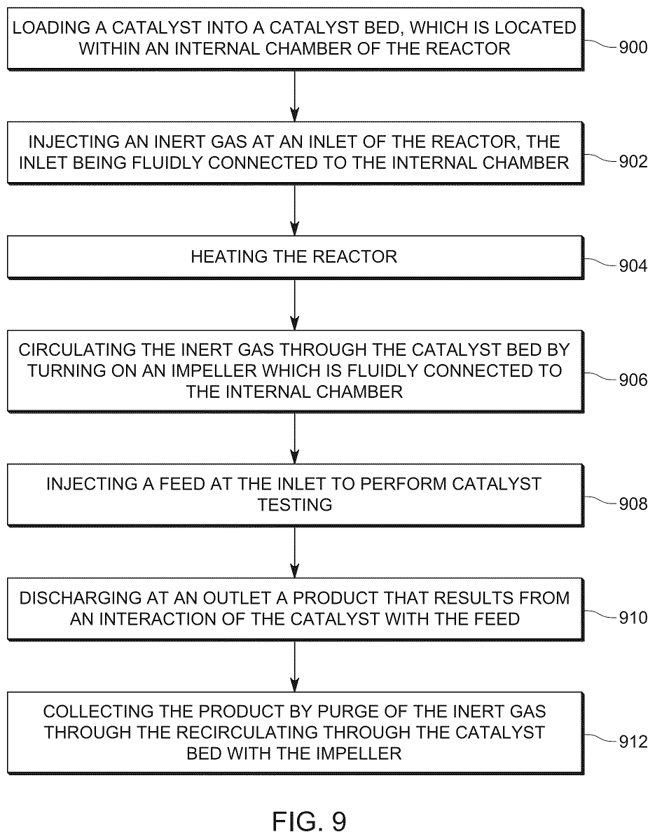

A method for catalyst screening in continuous mode using an internal circulation catalytic reactor is now discussed with regard to FIG. 9. The method includes a step 900 of loading a catalyst into a catalyst bed, which is located within an internal chamber of the reactor, a step 902 of injecting an inert gas at an inlet of the reactor, the inlet being fluidly connected to the internal chamber, a step 904 of heating the reactor to the desired temperature and adjusting the pressure in the reactor, a step 906 of circulating the inert gas through the catalyst bed by an impeller at the desired rotation rate which is fluidly connected to the internal chamber (note that steps 902 to 906 may be omitted as the reactor may be heated in other ways), a step 908 of injecting a feed at the inlet of the reactor to perform catalyst testing by internal circulation due to the impeller, a step 910 of discharging at an outlet a product that results from an interaction of the catalyst with the feed, and an optional step 912 of collecting further product, i.e., discharging, by purge of the inert gas through the recirculating through the catalyst bed with the impeller. The impeller is configured to discharge the recirculated inert gas and feed at a non-zero angle relative to a horizontal radial axis R.

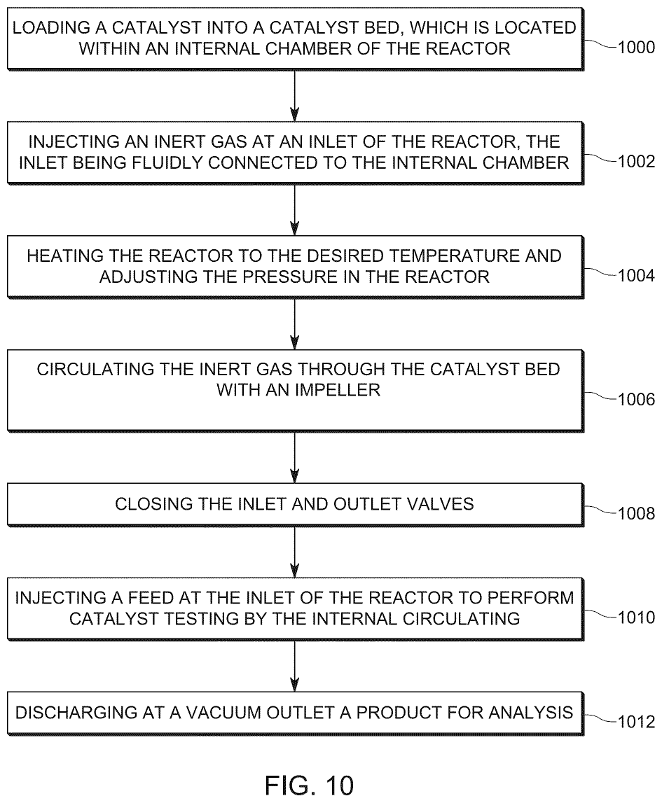

A method for catalyst screening in discontinuous mode using an internal circulation catalytic reactor is now discussed with regard to FIG. 10. The method includes a step 1000 of loading a catalyst into a catalyst bed, which is located within an internal chamber of the reactor, a step 1002 of injecting an inert gas at an inlet of the reactor, the inlet being fluidly connected to the internal chamber, a step 1004 of heating the reactor to the desired temperature and adjusting the pressure in the reactor, a step 1006 of circulating the inert gas through the catalyst bed with by an impeller at the desired rotation rate which is fluidly connected to the internal chamber, a step 1008 of closing the inlet and outlet valves, a step 1010 of injecting a feed at the inlet of the reactor to perform catalyst testing by the internal circulating, a step 1012 of discharging at a vacuum outlet a product for analysis. The impeller is configured to discharge the recirculated inert gas and feed at a non-zero angle relative to a horizontal radial axis R.

The disclosed embodiments provide an internal circulation catalytic reactor that has a curved impeller and a rounder reactor body with aerodynamic shapes, to promote interactions between a stationary zone within the body of the reactor and a rotating zone within the impeller. Together with a reduced height, the disclosed embodiments are able to reproduce actual operating conditions from the lab scale for catalyst screening in packed/fluidized modes under continuous or discontinuous processes. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.
[1] German Patent Application DE 20 2014 006 675 U1, published 2014.
[2] U.S. Pat. No. 5,102,628.

1. An internal circulation catalytic reactor comprising:
a body extending along a longitudinal axis Z and defining an internal chamber;
a catalyst bed located within the internal chamber, the catalyst bed being configured to hold a catalyst;
an inlet fluidly connected to the catalyst bed and configured to receive a feed;
an outlet fluidly connected to the catalyst bed and configured to discharge a product generated by an interaction of the feed and the catalyst; and
an impeller fluidly connected to the catalyst bed and configured to circulate the feed through the catalyst bed,
wherein the impeller is configured to discharge a recirculate feed at a non-zero angle relative to a horizontal radial axis R.

2. The reactor of claim 1, wherein the impeller comprises:
an impeller body;
a top curved plate attached to the impeller body, the top curved plate having a proximal end that extends radially from the impeller body, and having a distal end that extends along a direction that makes the non-zero angle with the radial axis R; and
a bottom inclined plate that defines with the top curve plate a rotational zone in which the feed is rotated.

3. The reactor of claim 2, wherein the bottom inclined plate is inclined with another non-zero acute angle relative to the radial axis R.

4. The reactor of claim 2, wherein the bottom inclined plate is attached with vanes to the top curved plate.

5. The reactor of claim 2, wherein the body of the impeller terminates with a water drop-shaped region, which is central to the top curved plate.

6. The reactor of claim 2, wherein the top curved plate and the bottom inclined plate define an internal rotational volume and one or more outlets.

7. The reactor of claim 6, wherein the feed from the internal rotational volume is released into a stationary volume around the impeller through the one or more outlets, at a non-zero angle relative to the radial axis R and the longitudinal axis Z.

8. The reactor of claim 7, wherein the one or more outlets is fluidly connected with an annulus formed between an inner wall of the internal chamber and the catalyst basket, and the annulus is curved.

9. The reactor of claim 8, wherein an entire length of the annulus is curved.

10. The reactor of claim 8, wherein the annulus extends from the impeller to the inlet.

11. The reactor of claim 1, wherein the outlet is located between the impeller and the inlet.

12. An impeller for an internal circulation catalytic reactor, the impeller comprising:
an impeller body;
a top curved plate attached to the impeller body, the top curved plate having a proximal end that extends radially from the impeller body, and having a distal end that extends along a direction that makes a non-zero angle with the radial axis R; and
a bottom inclined plate that defines with the top curve plate a rotational zone in which a feed is rotated.

13. The impeller of claim 12, wherein the top curved plate and the bottom inclined plate are configured to discharge a recirculated feed at a non-zero angle relative to the horizontal radial axis R.

14. The impeller of claim 12, wherein the bottom inclined plate is inclined with a non-zero angle relative to the radial axis R.

15. The impeller of claim 12, wherein the bottom inclined plate is attached with vanes to the top curved plate.

16. The impeller of claim 12, wherein the body of the impeller terminates with a water drop-shaped region, which is central to the top curved plate.

17. The impeller of claim 12, wherein the top curved plate and the bottom inclined plate define the rotational volume and one or more outlets.

18. The impeller of claim 17, wherein the feed from the rotational volume is released into a stationary volume around the impeller, through the one or more outlets, at a non-zero angle relative to the radial axis R and the longitudinal axis Z.

19. A method for selecting a catalyst with an internal circulation catalytic reactor, the method comprising:
loading a catalyst into a catalyst bed, which is located within an internal chamber of the reactor;
injecting a feed at an inlet of the reactor, the inlet being fluidly connected to the catalyst bed;
circulating the feed through the catalyst bed with an impeller which is fluidly connected to the catalyst bed;
discharging at an outlet a product that results from an interaction of the catalyst with the feed; and
recirculating a remainder of the feed through the catalyst bed with the impeller,
wherein the impeller is configured to discharge the recirculated feed at a non-zero angle relative to a horizontal radial axis R.

20. The method of claim 19, wherein the impeller has a top curved plate attached to an impeller body, the top curved plate having a proximal end that extends radially from the impeller body, and having a distal end that extends along a direction that makes the non-zero angle with the radial axis R, and a bottom inclined plate that defines with the top curve plate a rotational zone in which the feed is rotated.
